(19) United States
(12) Patent Application Publication
(10) Pub. No.: US 2016/0303468 A1
(43) Pub. Date: Oct. 20, 2016

(54) Money Counting Board Game

(71) Applicant: Stephanie Foster, Oak Lawn, IL (US)

(72) Inventor: Stephanie Foster, Oak Lawn, IL (US)

(21) Appl. No.: 15/133,814

(22) Filed: Apr. 20, 2016

Related U.S. Application Data
(60) Provisional application No. 62/149,833, filed on Apr. 20, 2015.

(51) Int. Cl. A63F 3/00; G09B 19/02; A63F 3/04

(52) U.S. Cl. CPC A63F 3/00063; A63F 3/04; G09B 19/02; A63F 2003/00066

(57) ABSTRACT

A board game and method of playing a board game that is designed to promote familiarity and proficiency with currency. The board game includes a game board having a plurality of spaces disposed along a perimeter thereof, game pieces, a spinner, a deck of cards, and imitation money. Each player places a game piece on a starting space on the board. The player advances their game pieces by spinning the spinner and moving the game piece the number of spaces as indicated by the spinner. Depending on which space a player lands on, they must collect money, pay money or purchase an item. The paying or purchasing spaces require a player to count out the stated amount in various methods using different denominations of currency, thus enforcing basic monetary skills.

### CROSS REFERENCE TO RELATED APPLICATIONS

This application claims the benefit of U.S. Provisional Application No. 62/149,833 filed on Apr. 20, 2015. The above identified patent application is herein incorporated by reference in its entirety to provide continuity of disclosure.

### BACKGROUND OF THE INVENTION

The present invention relates to board games. More specifically, the present invention relates to board games with an aim to teach math skills concerning various denomination of currency.

Recently there has been a shift in curriculum of elementary and high schools in the United States in order to satisfy the requirements of the Common Core State Standards Initiative. Students are required to show proficiency in mathematics at each grade level. Included in these standards is the requirement for students to demonstrate the ability to solve word problems involving dollar bills, quarters, dimes, nickels, and pennies as well as understand and use the $ and ¢ symbols appropriately.

Board games have long been a staple of entertainment for children of all ages, frequently offering skill building opportunities within an enjoyable and playful experience. While games exists that include imitation money and the ability to purchase items with that money, there lacks a game with both paper bills and coins where the game is designed to teach and test the ability of a player to represent monetary amounts using various combinations of currency denominations.

### SUMMARY OF THE INVENTION

In view of the foregoing disadvantages inherent in the known types of board games now present in the prior art, the present invention provides a new board game wherein the same can be utilized for providing convenience for the user when playing a board game with the intention of building mathematical skills relating to money while being entertaining. The present invention provides a board game and a method of playing a board game comprising a game board having a plurality of spaces disposed along a perimeter thereon, game pieces, a spinner, a deck of cards, and imitation money. Each player places a game piece on a starting space on the board. The players take turns advancing their game pieces by spinning the spinner and moving the game piece the number of spaces as indicated by the spinner. Depending on which space a player lands on, they must collect money, pay money or purchase an item. The paying or purchasing spaces require a player to count out the stated amount in various methods using different denominations of currency, thus enforcing basic monetary skills. The game ends when only one player is left with money in their hand, or after a predetermined time period.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a top down view of an embodiment of the game board of the present invention.

FIG. 2 shows a top down view of the spinner of the present invention.

FIG. 3 shows a flow chart of a player's turn of the board game of the present invention.

### DETAILED DESCRIPTION OF THE INVENTION

Reference is made herein to the attached drawings. Like reference numerals are used throughout the drawings to depict like or similar elements of the money counting board game. The figures are intended for representative purposes only and should not be considered to be limiting in any respect.

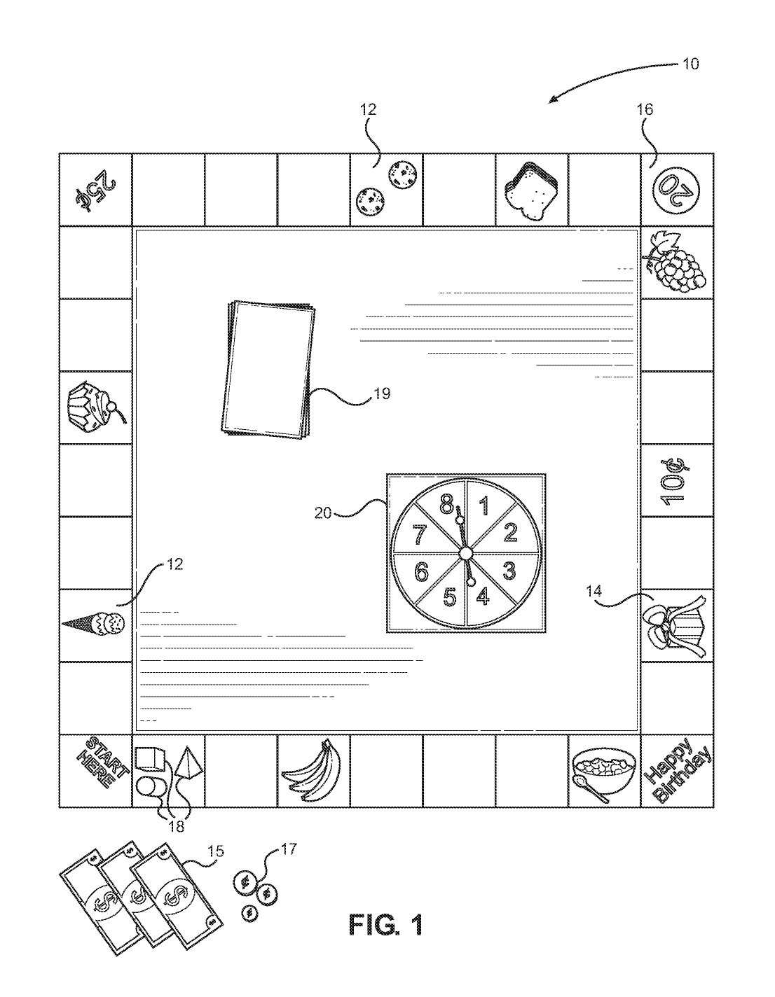

Referring now to FIG. 1, there is shown a top down view of an embodiment of the game board of the money counting board game. The board game comprises a game board 10, a plurality of game pieces 18, a deck of cards 19, a spinner 20, and imitation money 15, 17. In one embodiment of the board game, the game board 10 is substantially rectangular in shape and comprises a series of spaces 12, 14, 16 disposed along the outer perimeter so as to form a continuous path. A spinner 20 is used to determine how many spaces a player must move their game piece 18 each turn. Each space that a player can land on falls into one of three categories: a food item space 12, a gift space 14, or an instruction space 16. When a player lands on a food item 12, they are required to turn over a card from the deck 19.

The imitation money in is provided in various denominations. In one embodiment of the money counting game, the game uses a number of paper bills 15 such as one dollar bills, five dollar bills, ten dollar bills and twenty dollar bills. The game also uses coins 17, such as imitation pennies, nickels, dimes and quarters. Other embodiments include lesser common denominations, such as fifty dollar bill and a half dollar coin. The imitation money is stored in a bank area.

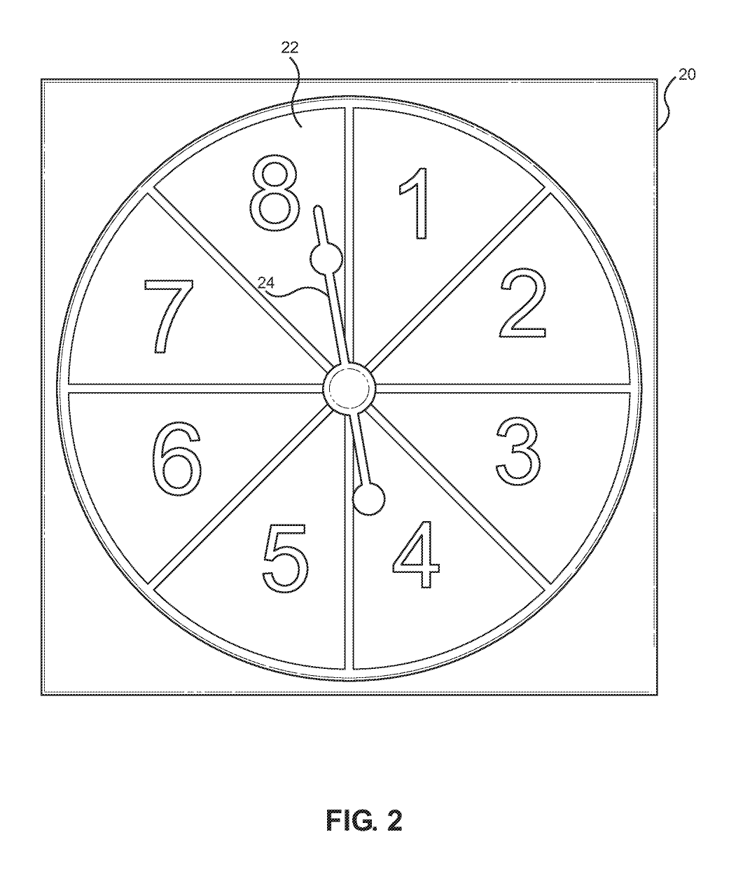

Referring now to FIG. 2 shows a top down view of the spinner of the money counting board game. The spinner 20 includes a base having an arrow 24 rotatably attached thereto. The spinner also includes numbered divisions 22 disposed on an upper surface thereof. In order to determine the amount spaces to mover the game piece, a player spins the arrow 24 of the spinner 20 and moves their player piece 18 the corresponding number of spaces along the continuous path. In the illustrated embodiment, the player may move anywhere between one and eight spaces per turn depending on where the arrow 24 is pointing to when it stops spinning.

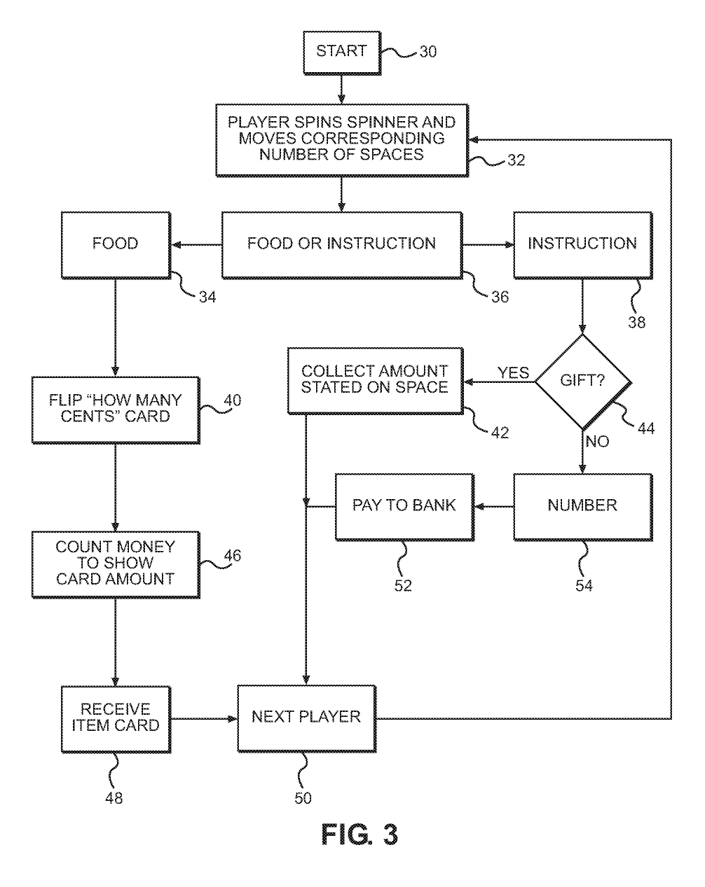

Referring now to FIG. 3, there is shown a flow chart of a player's turn of the money counting board game. Each player receives a starting amount of money. For example, each player can start with twenty dollars made up of various smaller denominations of bills 15 and coins 17. A player starts 30 a turn by spinning the spinner 32 whereby the arrow stops on a number on the spinner. The player moves their game piece that many spaces along the continuous path of spaces along the game board. The game piece will either land on a food space or an instruction space 36. If the game piece lands on a food space 34, the player must flip over a card from the deck of cards 40. In one embodiment of the game, the cards are labeled “How Many Cents” on the back side of each card. The front side of each card displays an amount of money both in numerals and in words. For example, a card can say “thirty five cents” and “35¢”. The player is then required to show that amount in various forms. Following the previous example, the player can show the thirty five cent amount using a quarter and two nickel. Then the player must show another configuration of thirty five cents, such as three dimes and five pennies. After the player has counted the amount in various ways 46, that amount is given to the bank and the player receives a card 48 with a matching depiction of the food item. The game moves on to the next player 50 and the turn start over again 30.

Alternatively, if a player lands on an instruction space 38, they follow the written instruction displayed directly on the board. If a player lands on a gift space 44, they collect a specific amount from the bank. There can be various images that depict a gift space, such as a picture of a boxed gift, or the words “Happy Birthday.” Each of these spaces indicates directly on the space how much the player will collect 42 from the bank. If a player lands on a number space 54, the player must count out the amount in various ways, similar to a food item space, and give the money to the bank 52. Unlike the food item spaces, however, the player does not receive anything in return for the money given to the bank for a number space. The game moves on to the next player 50 and the turn start over again 30. The game ends when only one player is left with money in their hand, or after a predetermined time period.

It is therefore submitted that the instant invention has been shown and described in various embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A money counting board game, comprising:
a game board;
a plurality of spaces disposed along a perimeter of the game board, forming a continuous path;
a deck of cards, wherein a denomination of currency is displayed on a front side of each card;
a spinner comprising a base and an arrow rotatably fastened thereto, the base having a plurality of numbered divisions, each division identified with a number;
a plurality of game pieces;
a plurality of various denomination of imitation money.

2) The money counting board game of claim 1, wherein the denomination of currency is displayed in both words and in numerals.

3) The money counting board game of claim 1, wherein the plurality of spaces contains spaces with depictions of food items displayed thereon.

4) The money counting board game of claim 1, wherein the plurality of spaces contains spaces with a number displayed thereon.

5) A method of playing a board game, comprising the steps of:
providing a game board having a perimeter and a plurality of spaces disposed therealong;
providing each of a plurality of players with a game piece;
positioning each player game piece on a start space;
spinning a spinner to determine the number of spaces a player must move their game piece along the plurality of spaces;
turning a card over from a deck of cards to reveal and amount owed if game piece lands on a space displaying a food item;
paying the amount shown on the card to the bank and receiving an item card;
paying the amount shown on the space if game piece lands on an instruction space; and
collecting the amount shown on the space if the game piece lands on a gift space.

6) The method of playing a board game of claim 5, wherein a player leaves the game when the player has no more imitation money in their hand, and wherein the game ends when only one player remains.

7) The method of playing a board game of claim 5, wherein the game ends after a predetermined period of time.
